(19) United States
(12) Patent Application Publication
(10) Pub. No.: US 2022/0127479 A1
(43) Pub. Date: Apr. 28, 2022

(54) Recording Method

(71) Applicant: Seiko Epson Corporation, Tokyo (JP)

(72) Inventors: Ryota IMAI, Shiojiri (JP); Takayoshi KAGATA, Shiojiri (JP)

(21) Appl. No.: 17/511,619

(22) Filed: Oct. 27, 2021

(30) Foreign Application Priority Data
Oct. 28, 2020 (JP) 2020-180424

(51) Int. Cl. C09D 11/322; B41M 5/00; C09D 11/36; D06P 5/28

(52) U.S. Cl. CPC C09D 11/322; D06P 5/006; C09D 11/36; B41M 5/0047

(57) ABSTRACT

A recording method includes a colored ink adhering step of adhering a colored ink composition to an intermediate transfer medium by an ink jet method to form a recording region A, and a clear ink adhering step of adhering a clear ink composition to at least a portion of the recording region A. The colored ink composition contains a sublimation dye, a water-soluble organic solvent, and water, and the intermediate transfer medium has a peeling layer containing a resin.

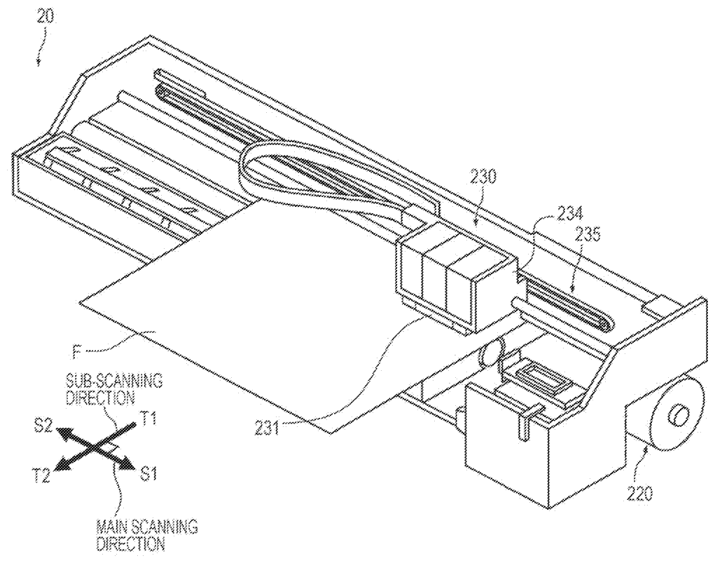

The present application is based on, and claims priority from JP Application Serial Number 2020-180424, filed Oct. 28, 2020, the disclosure of which is hereby incorporated by reference herein in its entirety.

### BACKGROUND

### 1. Technical Field

The present disclosure relates to a recording method.

### 2. Related Art

A sublimation transfer method transfers a sublimation dye, adhered to an intermediate recording body, to a fabric such as polyester or the like by, for example, an ink jet method. In recent years, various products have been simply produced by recording on fabrics using the sublimation transfer method, and the sublimation transfer method has been desired to be applied to fabrics other than polyester.

However, a usual sublimation transfer method has a problem of difficulty in forming high-quality images on fabrics other than polyester. Thus, a method using transfer paper having a release agent layer is known. For example, WO2007/111302 discloses a dry transfer textile printing method using transfer paper, which has a release agent layer and an ink receiving layer, and including transferring and fixing a water-soluble dye ink to a fabric by pressurized heating treatment of the transfer paper, to which an ink composition has been adhered, for the fabric.

However, it was found that the method described in WO2007/111302 has a problem that transfer does not satisfactorily proceed in a low-duty portion.

### SUMMARY

According to an aspect of the present disclosure, a recording method includes a colored ink adhering step of adhering a colored ink composition to an intermediate transfer medium by an ink jet method to form a recording region A, and a clear ink adhering step of adhering a clear ink composition to at least a portion of the recording region A. The colored ink composition contains a sublimation dye, a water-soluble organic solvent, and water, and the intermediate transfer medium has a peeling layer containing a resin.

According to an aspect of the present disclosure, an ink jet recording apparatus used for the recording method described above includes a nozzle which ejects a colored ink composition, and a nozzle which ejects a clear ink composition. The colored ink composition contains a sublimation dye, a water-soluble organic solvent, and water, and the clear ink composition contains a water-soluble organic solvent and water.

### BRIEF DESCRIPTION OF THE DRAWING

FIGURE is a perspective view showing a serial-system ink jet apparatus according to an embodiment of the present disclosure.

### DESCRIPTION OF EXEMPLARY EMBODIMENTS

An embodiment of the present disclosure (referred to as a “present embodiment” hereinafter) is described in detail below, but the present disclosure is not limited to this, and various modifications can be made within a range not deviating from the gist of the present disclosure.

### 1. Recording Method

A recording method according to a present embodiment includes a colored ink adhering step of adhering a colored ink composition to an intermediate transfer medium by an ink jet method to form a recording region A, and a clear ink adhering step of adhering a clear ink composition to at least a portion of the recording region A. The colored ink composition contains a sublimation dye, a water-soluble organic solvent, and water, and the intermediate transfer medium has a peeling layer containing a resin.

As described above, a known example of a usual sublimation transfer method is a method including transferring a portion of a layer of an intermediate transfer medium to a recording medium. However, it was found that depending on the ejection amount of the colored ink composition adhered to the intermediate transfer medium, adhesive force to the recording medium is not satisfactorily exhibited, thereby causing a problem that transfer does not proceed.

On the other hand, in the present embodiment using the clear ink composition, the amount of the colored ink composition ejected to a low-duty portion is compensated by adhering the clear ink composition to at least a portion of the recording region A, and thus good transfer can be performed over the whole of the recording region, thereby improving transferability in the low-duty portion. Each of the steps is described in detail below.

### 1.1. Colored Ink Adhering Step

The colored ink adhering step is a step of adhering the colored ink composition to the intermediate transfer medium by an ink jet method to form the recording region A. In an ink jet system, an ink composition can be ejected by using a known ink jet recording apparatus. An ejection method is not particularly limited, but for example, a piezo system, a system of ejecting an ink using bubbles generated by heating the ink, or the like can be used.

In the colored ink adhering step, the colored ink composition is preferably adhered to the peeling layer of the intermediate transfer medium, forming the recording region A on the peeling layer.

### 1.1.1. Colored Ink Composition

The colored ink composition contains the sublimation dye, the water-soluble organic solvent, and water, and if required, may further contain a surfactant, a dispersant, etc.

### 1.1.1.1. Sublimation Dye

In the present embodiment, the “sublimation dye” represents a dye having the property of being sublimated by heating. Examples of the sublimation dye include, but are not particularly limited to, C. I. Disperse Yellow 3, 7, 8, 23, 39, 51, 54, 60, 71, and 86; C. I. Disperse Orange 1, 1:1, 5, 20, 25:1, 33, 56, and 76; C. I. Disperse Brown 2; C. I. Disperse Red 11, 50, 53, 55, 55:1, 59, 60, 65, 70, 75, 93, 146, 158, 190, 190:1, 207, 239, and 240; C. I. Disperse Violet 8, 17, 23, 27, 28, 29, 36, and 57; C. I. Disperse Blue 14, 19, 26, 26:1, 35, 55, 56, 58, 64, 64:1, 72, 72:1, 81, 81:1, 91, 95, 108, 131, 141, 145, and 359, and the like.

### 1.1.1.2. Water-Soluble Organic Solvent

Examples of the water-soluble organic solvent include, but are not particularly limited to, glycerin; glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, and the like; glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, triethylene glycol monomethyl ether, triethylene glycol monobutyl ether, and the like; nitrogen-containing solvents such as 2-pyrrolidone, N-methyl-2-pyrrolidone, N-ethyl-2-pyrrolidone, and the like; and alcohols such as methanol, ethanol, n-propyl alcohol, iso-propyl alcohol, n-butanol, 2-butanol, tert-butanol, iso-butanol, n-pentanol, 2-pentanol, 3-pentanol, tert-pentanol, and the like. The water-soluble organic solvents may be used alone or in combination of two or more.

Among these, glycerin, glycols, and glycol monoethers are preferred, and glycerin, propylene glycol and triethylene glycol monomethyl ether are more preferred. The use of such a water-soluble organic solvent tends to more improve transferability in a low-duty portion.

The content of the water-soluble organic solvent relative to the total amount of the colored ink composition is preferably 7.5% to 35% by mass, more preferably 10% to 30% by mass, and still more preferably 15% to 25% by mass. When the content of the water-soluble organic solvent is within the range described above, there is a tendency to more improve ejection stability, to more improve wettability to the intermediate transfer medium, and to more improve transferability in a low-duty portion.

### 1.1.1.3. Water

The content of water relative to the total amount of the colored ink composition is preferably 60% to 90% by mass, more preferably 65% to 85% by mass, and still more preferably 70% to 80% by mass.

### 1.1.1.4. Surfactant

Examples of the surfactant include, but are not particularly limited to, an acetylene glycol-based surfactant, a fluorine-based surfactant, and a silicone-based surfactant. The surfactants may be used alone or in combination of two or more.

The acetylene glycol-based surfactant is not particularly limited, but is, for example, preferably one or more selected from 2,4,7,9-tetramethyl-5-decyne-4,7-diol, alkylene oxide adducts of 2,4,7,9-tetramethyl-5-decyne-4,7-diol, 2,4-dimethyl-5-decyne-4-ol, and alkylene oxide adducts of 2,4-dimethyl-5-decyne-4-ol.

Examples of the fluorine-based surfactant include, but are not particularly limited to, perfluoroalkylsulfonate salts, perfluoroalkylcarboxylate salts, perfluoroalkylphosphate esters, perfluoroalkylethylene oxide adducts, perfluoroalkylbetaine, and perfluoroalkylamine oxide compounds.

Examples of the silicone-based surfactant include a polysiloxane-based compound, polyether-modified organosiloxane, and the like.

Among these, the silicone-based surfactant is preferred. The use of such a surfactant tends to more improve ejection stability, to more improve wettability to the intermediate transfer medium, and to more improve the transferability in a low-duty portion.

The content of the surfactant relative to the total amount of the colored ink composition is preferably 0.1% to 2.0% by mass, more preferably 0.2% to 1.5% by mass, and still more preferably 0.3% to 1.0% by mass. When the content of the surfactant is within the range described above, there is a tendency to more improve ejection stability, to more improve wettability to the intermediate transfer medium, and to more improve the transferability in a low-duty portion.

### 1.1.1.5. Dispersant

The colored ink composition may contain a dispersant. The containing of the dispersant tends to more improve the dispersion stability of the sublimation dye and tends to more improve storage stability, ejection stability, etc. Examples of the dispersant include, but are not particularly limited to, an anionic dispersant, a nonionic dispersant, and a polymeric dispersant. The dispersants may be used alone or in combination of two or more.

Examples of the anionic dispersant include, but are not particularly limited to, an aromatic sulfonic acid-formalin condensate, a β-naphthalenesulfonic acid-formalin condensate, an alkylnaphthalenesulfonic acid-formalin condensate, and a creosote oil sulfonic acid-formalin condensate.

Examples of an aromatic sulfonic acid include, but are not particularly limited to, alkylnaphthalene sulfonic acid such as creosote oil sulfonic acid, cresol sulfonic acid, phenol sulfonic acid, β-naphthol sulfonic acid, methylnaphthalene sulfonic acid, butylnaphthalene sulfonic acid, and the like; a mixture of β-naphthalene sulfonic acid and β-naphthol sulfonic acid; a mixture of cresol sulfonic acid and 2-naphthol-6-sulfonic acid; lignin sulfonic acid; and the like.

Examples of the nonionic dispersant include, but are not particularly limited to, a phytosterol ethylene oxide adduct, a cholestanol ethylene oxide adduct, and the like.

Examples of the polymeric dispersant include, but are not particularly limited to, polyacrylic acid partial alkyl esters, polyalkylene polyamine, polyacrylate salts, styrene-acrylic acid copolymer, vinylnaphthalene-maleic acid copolymer, and the like.

The content of the dispersant relative to the total amount of the sublimation dye is preferably 1% to 200% by mass and more preferably 50% to 150% by mass. When the content of the dispersant is within the range described above, there is a tendency to more improve the dispersion stability of the sublimation dye and to more improve storage stability, ejection stability, etc.

### 1.1.1.6. Other Additives

If required, the colored ink composition may contain an anti-mold agent, an antiseptic agent, an antioxidant, an ultraviolet absorber, a chelating agent, an oxygen absorber, a pH adjuster (for example, triethanolamine, adipic acid, or potassium hydroxide), or a solubilizer, and other various additives which can be used in usual inks.

### 1.1.1.7. Surface Tension

The surface tension S₁ at 25° C. of the colored ink composition is preferably 20 to 30 mN/m, more preferably 21 to 27 mN/m, and still more preferably 22 to 25 mN/m. When the surface tension S₁ of the colored ink composition is within the range described above, there is a tendency to more improve ejection stability, to more improve wettability to the intermediate transfer medium. and to more improve the transferability in a low-duty portion.

The surface tension in the present embodiment can be measured by at a liquid temperature of 25° C. by a Wilhelmy method using a surface tensiometer (surface tensiometer, CBVP-Z manufactured by Kyowa Interface Science Co., Ltd.).

### 1.1.2. Intermediate Transfer Medium

The intermediate transfer medium used in the present embodiment has the peeling layer. By using the intermediate transfer medium, the peeling layer can be separated from the intermediate transfer medium and then transferred to a recording medium in a transfer step described later. This can produce the recording medium on which the peeling layer has been adhered.

The intermediate transfer medium has the peeling layer formed on a substrate, and the peeling layer is configured to have peelability that the peeling layer is separated from the substrate by heating so as to be adhered to the recording medium by heating in the state of facing the recording medium. From this viewpoint, the glass transition point of the resin contained in the peeling layer is preferably 100° C. or more and 200° C. or less. This enables to separate the peeling layer from the intermediate transfer medium and adhere it to the recording medium by heating in the transfer step.

In the present embodiment, if required, the intermediate transfer medium may have another layer other than the peeling layer. The other layer is, for example, an ink receiving layer formed on the surface of the peeling layer on the side opposite to the substrate side. For example, in the present embodiment, the colored ink composition may be adhered to the ink receiving layer in the colored ink adhering step, and the peeling layer may be separated from the intermediate transfer medium in the transfer step so that the peeling layer and the ink receiving layer are adhered to the recording medium. In this case, the two layers, the ink receiving layer and the peeling layer, are transferred to the recording medium so that the ink receiving layer is adhered to the recording medium. Also, in this case, the colored ink composition adhered to the ink receiving layer may be sublimated and diffused to the peeling layer from the ink receiving layer by heating in parallel with the transfer in the transfer step.

Also, the peeling layer is preferably a transparent layer, and the ink receiving layer is preferably an opaque layer, particularly, a white layer. Thus, when the colored ink composition adhered to the ink receiving layer is sublimated and diffused from the ink receiving layer to the peeling layer by heating in the transfer step, the white ink receiving layer serves as a layer which conceals the color of the recording medium, and an image with good transferability can be formed by diffusing the sublimation dye to the peeling layer formed on the ink receiving layer regardless of the color of the recording medium.

The resin contained in the peeling layer is not particularly limited, but is, for example, one or more selected from the group consisting of polyester, polystyrene, polyacryl, polystyrene-acrylic resin, poly(ethylene-vinyl acetate), and a polymer based on diallyl methyl ammonium chloride. The containing of such a resin tends to more improve peelability, to more improve the transferability in a low-duty portion, and to more suppress blurring.

Examples of the intermediate transfer medium include, but are not particularly limited to, Subli-Light (No-cut), Subli-Flex (No-cut), and the like manufactured by Forever Inc.

1.2. Clear ink adhering step

The clear ink adhering step is a step of adhering the clear ink composition to at least a portion of the recording region A. The method for adhering the clear ink composition is not limited to the ink jet method, and roller coating, spray coating, or the like may be used.

Among these, the ink jet method is preferred in view of the fact that the adhesion position and adhesion amount of the clear ink composition can be highly precisely controlled. The use of this method enables to adjust the position and amount of the clear ink composition adhered to the recording region A, and thus enables to produce a recorded matter having high transferability and little blurring by the transfer step described later. Specifically, the use of the ink jet method can enhance transferability by adhering a relatively large amount of the clear ink composition to a portion of the recording region A with a small amount of the colored ink composition adhered thereto, and when the ink compositions are excessively adhered, the use can suppress the occurrence of blurring by adhering a relatively small amount of the clear ink composition to a portion of the recording region A with a large amount of the colored ink composition adhered thereto.

More specifically, when the recording region A formed in the colored ink adhering step has a recording region A1 where the amount of the colored ink composition adhered thereto is less than 21 mg/inch², the clear ink composition is preferably adhered to the recording region A1. This enables the clear ink composition to be adhered according to the amount of the colored ink composition adhered to the recording region A. Thus, transferability can be more improved over the whole of the recording region A, and blurring can be suppressed.

In the clear ink adhering step, the clear ink composition is preferably adhered so that the total amount of the colored ink composition and clear ink composition adhered to the recording region A falls within a predetermined range. Specifically, the total amount of the colored ink composition and clear ink composition adhered to the recording region A is preferably 6.3 to 25.2 mg/inch², more preferably 7.4 to 25.2 mg/inch², and still more preferably 8.4 to 21 mg/inch². The total adhesion amount within the range described above tends to more improve transferability.

In the clear ink composition adhering step, the clear ink composition is preferably further adhered to a non-recording region B adjacent to the recording region A. This tends to more improve the quality of a boundary portion and a thin line portion of the recording region A.

### 1.2.1. Clear Ink Composition

In the present embodiment, the “clear ink” is not an ink used for coloring, but an ink used for another purpose. In the present embodiment, when the clear ink composition is adhered to at least a portion of the recording region A, the amount of liquid in the recording region A can be controlled to a predetermined amount or more in the transfer step described later. This tends to more improve the transferability in a low-duty portion. Also, when the clear ink composition is further adhered to the non-recording region B, transfer is allowed to effectively proceed even in a peripheral region of the recording region A beyond the recording region A, and thus the quality of a boundary portion and a thin line portion in the recording region A tends to be more improved. The clear ink does not include simple water.

Examples of the components contained in the clear ink composition include the same examples as described above for the components, excluding the sublimation dye, of the colored ink composition. The clear ink composition contains a water-soluble organic solvent and water, and if required, may further contain a surfactant etc. The components contained in the clear ink composition may be the same as or different from those contained in the colored ink composition.

### 1.2.1.1. Water-Soluble Organic Solvent

The water-soluble organic solvent is preferably glycerin, glycols, or glycol monoethers, more preferably glycerin, propylene glycol, triethylene glycol, triethylene glycol monomethyl ether, or triethylene glycol monobutyl ether, and still more preferably glycerin, propylene glycol, or triethylene glycol monomethyl ether. The use of such a water-soluble organic solvent tends to more improve transferability in a low-duty portion.

The content of the water-soluble organic solvent relative to the total amount of the clear ink composition is preferably 7.5% to 35% by mass, more preferably 10% to 30% by mass, and still more preferably 15% to 25% by mass. When the content of the water-soluble organic solvent is within the range described above, there is a tendency to more improve wettability to the intermediate transfer medium and to more improve transferability in a low-duty portion.

The colored ink composition and the clear ink composition preferably contain the same one or more water-soluble organic solvents and more preferably contain the same two or more water-soluble organic solvents. This allows sublimation/diffusion and transfer of the peeling layer to more preferably proceed in the transfer step described later, and tends to more improve transferability of the resultant recorded matter and more suppress blurring.

### 1.2.1.2. Water

The content of water relative to the total amount of the clear ink composition is preferably 70% to 99.5% by mass, more preferably 70% to 95% by mass, and still more preferably 75% to 90% by mass.

### 1.2.1.3. Surfactant

The surfactant is preferably an acetylene glycol-based surfactant or a silicone-based surfactant, and more preferably a silicone-based surfactant. The colored ink composition and the clear ink composition preferably contain the same one or more surfactants. This allows sublimation/diffusion and transfer of the peeling layer to more preferably proceed in the transfer step described later, and tends to more improve transferability of the resultant recorded matter and more suppress blurring.

The content of the surfactant relative to the total amount of the clear ink composition is preferably 0.1% to 2.0% by mass, more preferably 0.2% to 1.5% by mass, and still more preferably 0.3% to 1.0% by mass. When the content of the surfactant is within the range described above, there is a tendency to more improve transferability in a low-duty portion.

### 1.2.1.4. Surface Tension

The surface tension S₂ at 25° C. of the clear ink composition is preferably 20 to 40 mN/m, more preferably 21 to 32 mN/m, and still more preferably 22 to 28 mN/m. When the surface tension S₂ of the clear ink composition is within the range described above, there is a tendency to more improve ejection stability, to more improve wettability of the clear ink composition to the recording medium. and to more improve the transferability in a low-duty portion.

Also, the absolute value of difference between the surface tension S₁ of the colored ink composition and the surface tension S₂ of the clear ink composition is preferably within 5.0, more preferably within 4.0, and still more preferably within 3.0. When a difference between the surface tension S₁ and the surface tension S₂ is within the range described above, sublimation/diffusion and transfer of the peeling layer to more preferably proceed in the transfer step described later, thereby causing a tendency to more improve transferability of the resultant recorded matter and more suppress blurring. When a plurality of ink compositions are used as the colored ink composition, a difference in surface tension between each of the colored ink compositions and the clear ink composition is preferably within the range described above.

### 1.2.2. Recording Medium

Examples of the recording medium include, but are not particularly limited to, a fabric (a hydrophobic fiber fabric or the like), a resin (plastic) film, paper, wood, leather, glass, a metal, porcelain, and the like. The recording medium may have a three-dimensional shape such as a sheet shape, a spherical shape, a rectangular parallelopiped shape, or the like.

When the recording medium is a fabric, examples of the fibers constituting the fabric include, but are not particularly limited to, polyester fibers, nylon fibers, triacetate fibers, diacetate fibers, polyamide fibers, synthetic fibers or semi-synthetic fibers using two or more types of these fibers, natural fibers such as silk, cotton, wool, nylon, polyester, rayon, and the like, regenerated fibers such as rayon and the like. Also, a blend of two or more types of these fibers may be used.

Among these, a fabric containing cotton is preferred. Such a recording medium is frequently used as a fabric product, but a high-quality recorded matter is difficult to obtain by a usual sublimation transfer method, and the present disclosure is particularly useful.

When the recording medium is a resin (plastic) film, usable examples of the resin (plastic) film include, but are not particularly limited to, a polyester film, a polyurethane film, a polycarbonate film, a polyphenylene sulfide film, a polyimide film, a polyamide-imide film, and the like. The resin (plastic) film may be a laminate of a plurality of laminated layers or may be configured by a gradient material having a gradiently changing composition.

### 1.3. Transfer Step

The recording method of the present embodiment preferably further includes the transfer step of transferring an image formed in the recording region A to the surface of the recording medium by heating in a state where in the intermediate transfer medium, the surface having the recording region A formed thereon faces the surface of the recording medium. In this case, the transfer of the image includes transferring the image formed in the recording region A, together with the peeling layer of the intermediate transfer medium, to the recording medium.

The heating temperature in the transfer step is preferably 160° C. to 220° C., more preferably 160° C. to 190° C., and still more preferably 170° C. to 190° C. The heating temperature within the range described above tends to make it easy to peel and transfer the peeling layer from the intermediate transfer medium to the recording medium, and tends to more improve transferability of the resultant recorded matter and more suppress blurring.

The heating time in the transfer step is preferably 15 to 120 seconds, more preferably 20 to 90 seconds, and still more preferably 20 to 80 seconds. The heating time within the range described above tends to make it easy to peel and transfer the peeling layer from the intermediate transfer medium to the recording medium and to more improve transferability of the resultant recorded matter and more suppress blurring.

In the transfer step, heating is preferably performed in a state where the recording region A of the intermediate transfer medium and the recording medium are adhered to each other, and is more preferably performed in a pressurized state. The pressure in the transfer step is preferably 1.0 to 8.0 kN/cm² and more preferably 2.0 to 6.0 kN/cm². The pressure within the range described above tends to make it easy to peel and transfer the peeling layer from the intermediate transfer medium to the recording medium, and to more improve transferability of the resultant recorded matter and more suppress blurring.

The transfer step is preferably performed in a state where the total amount of the colored ink composition and the clear ink composition adhered to the recording region A is a predetermined value or more. More specifically, in performing the transfer step, the total amount of the colored ink composition and the clear ink composition adhered to the recording region A is preferably 5.0 mg/inch² or more, more preferably 5.9 to 25.2 mg/inch², and still more preferably 6.7 to 21 mg/inch². The total adhesion amount of 5.0 mg/inch² or more tends to more improve transferability over the whole of the recording region A. The total adhesion amount of 21 mg/inch² or less tends to more suppress blurring. When the amount of the colored ink composition adhered is 5.0 mg/inch² or more, the clear ink composition may not be adhered to that portion of the recording region A.

### 2. Ink Jet Recording Apparatus

An ink jet recording apparatus according to a present embodiment is an ink jet recording apparatus used for the recording method described above and includes a nozzle ejecting a colored ink composition and a nozzle ejecting a clear ink composition. The colored ink composition contains a sublimation dye, a water-soluble organic solvent, and water, and the clear ink composition contains a water-soluble organic solvent and water.

FIGURE is a perspective view showing a serial printer as an example of an ink jet apparatus. As shown in FIGURE, a serial printer 20 includes a transport section 220 and a recording section 230. The transport section 220 transports a recording medium F fed to the serial printer to the recording section 230 and discharges the recording medium after recording to the outside of the serial printer. Specifically, the transport section 220 has a feed roller and transports the fed recording medium F in a sub-scanning direction T1.

In addition, the recording section 230 includes a carriage 234 provided with an ink jet head 231, which has a nozzle ejecting the colored ink composition and a nozzle ejecting the clear ink composition to the recording medium F fed from the transport section 220, and a carriage moving mechanism 235, which moves the carriage 234 in the main scanning direction S1/S2 of the recording medium F.

The serial printer includes as the ink jet head 231 a head having a length shorter than the width of the recording medium, and recording is performed in a plurality of paths (multi-path) by moving the head. Also, the serial printer includes the head 231 mounted on the carriage 234 moved in the predetermined direction, and the colored ink composition and the clear ink composition are ejected to the recording medium by moving the head with the movement of the carriage. Thus, recording is performed in 2 or more paths (multi-path). The path is also referred to as “main scanning”. Sub-scanning is performed to transport the recording medium between the paths. That is, main scanning and sub-scanning are alternately performed.

The ink jet apparatus according to the present embodiment is not limited to the serial-system printer described above, and may be a line-system printer.

### EXAMPLES

The present disclosure is more specifically described below by using examples and comparatist examples. The present disclosure is not limited to the examples below.

### 1. Preparation of Ink Composition

Components were mixed to provide the compositions described in Table 1 below, preparing colored ink compositions and clear ink compositions. Table 1 shows the compositions in terms of % by mass.

TABLE 1

| | | | | | Clear ink | |
|---|---|---|---|---|---|---|
| | | Colored ink composition | | | composition | |
| | | 1 | 2 | 3 | 1 | 2 |
| Subli- | DB359 | 5.0% | | | | |
| mation | DR60 | | 5.0% | | | |
| dye | DY54 | | | 5.0% | | |
| Water- | Propylene | 5.0% | 5.0% | 5.0% | 5.0% | |
| soluble | glycol | | | | | |
| organic | Triethylene | | | | | 20.0% |
| solvent | glycol | | | | | |
| | Glycerin | 10.0% | 10.0% | 10.0% | 10.0% | 15.0% |
| | Triethylene | 5.0% | 5.0% | 5.0% | 5.0% | |
| | glycol | | | | | |
| | monomethyl | | | | | |
| | ether | | | | | |
| | Triethylene | | | | | 1.0% |
| | glycol | | | | | |
| | monobutyl | | | | | |
| | ether | | | | | |
| Surfac- | BYK348 | 0.5% | 0.5% | 0.5% | 0.5% | |
| tant | Olfine | | | | | 1.0% |
| | E1010 | | | | | |

| | | | | | |
|---|---|---|---|---|---|
| Water | 74.5% | 74.5% | 74.5% | 79.5% | 63.0% |
| Total | 100.0% | 100.0% | 100.0% | 100.0% | 100.0% |
| Surface tension | 23.2 | 23.4 | 23.5 | 23.3 | 29 |
| [mN/m] | | | | | |

The abbreviations and product components used in Table 1 are as follows.

### <Sublimation Dye>

DB359: C. I. Disperse Blue 359
DR60: C. I. Disperse Red 60
DY54: C. I. Disperse Yellow 54

### <Water-Soluble Organic Solvent>

Propylene glycol
Triethylene glycol
Glycerin
Triethylene glycol monomethyl ether
Triethylene glycol monobutyl ether
<Surfactant>
BYK 348 (silicone-based surfactant, manufactured by BYK Chemie Inc.)
Olfine E1010 (acetylene glycol-based surfactant, manufactured by Nissin Chemical Industry Co., .td.)

### 1.1. Measurement of Surface Tension

The surface tension of each of the ink compositions was measured at a liquid temperature of 25° C. by a Wilhelmy method using a surface tensiometer (surface tensiometer, CBVP-Z manufactured by Kyowa Interface Science Co., Ltd.).

### 2. Evaluation Method

### 2.1. Transferability

The colored ink compositions 1 to 3 were adhered to Subli-Light (No-cut) (manufactured by Forever Inc.) having a peeling layer with a resolution of 720 dpi×720 dpi and a duty described in Tables 2 and 3 by using an ink jet printer (PX-G930, manufactured by Seiko Epson Corporation) to form a recording region A with respective single-color solid patterns. In the recording region A, the printing positions of the colored ink compositions 1 to 3 were formed to be adjacent to each other.

Also, each of the clear ink compositions was adhered to the recording region A of the intermediate transfer medium with a duty described in Tables 2 and 3 by the same ink jet printer (PX-G930, manufactured by Seiko Epson Corporation).

Next, the formed region A was adhered to a recording medium (fabric) so as to face each other, and then transferred by first heating using a heat press machine (TP-608M, manufactured by Taiyo Seiki Co., Ltd.) under the conditions of 185° C., 30 seconds, and 4.2 kN/cm². After the completion of first heating, the intermediate transfer medium was removed from the recording medium over 10 seconds, and then the transferred product was fixed to the recording medium by second heating using the same press machine under the conditions of 185° C., 30 seconds, and 4.2 kN/cm². The time taken from the adhesion to transfer of the ink composition was 30 seconds. In addition, the room temperature was 25° C., and the humidity was 30%.

The “duty” represents a value calculated by a formula below, and “100% duty” represents that one ink droplet is adhered to each of all pixels. Duty (%)=Number of actual printed dots/(longitudinal resolution×transverse resolution)×100

In the formula, the “number of actual printed dots” is the number of actual printed dots per unit area, and “longitudinal resolution” and “transverse resolution” are each resolution per unit area.

In addition, when the inks used in the examples were adhered with each of the duties, the adhesion amount of any one of the inks was calculated by the following formula, and the adhesion amount of each ink with 100% duty was 21 mg/inch². Ink adhesion amount (mg/inch²)=21×duty (%)/100

It was confirmed by visual observation whether or not a portion where transfer does not proceed is present in the solid image formed as described above on the recording medium, and transferability was evaluated according to the following criteria.

### Evaluation Criteria

A: The center of the solid print portion was transferred at an area ratio of 100%.
B: The center of the solid print portion was transferred at an area ratio of 99% or more and less than 100%.
C: The center of the solid print portion was transferred at an area ratio of 90% or more and less than 99%.
D: The center of the solid print portion was transferred at an area ratio of 50% or more and less than 90%.
E: The center of the solid print portion was transferred at an area ratio of less than 50%.
   2.2. Blurring between solid pattern regions of colored ink compositions 1 to 3

It was confirmed by visual observation whether or not blurring occurs at the boundaries between the solid patterns of the colored ink compositions 1 to 3 formed as described above, and evaluation was made according to the following criteria.

### Evaluation Criteria

A: Blurring was not observed at the boundary portions.
B: Blurring was slightly observed at the boundary portions.
C: Blurring was significantly observed at the boundary portions.

### 2.3. Wet Rubbing Fastness

In a rubbing fastness test, the recording surface of the recording medium having the image formed thereon as described above was rubbed 150 times with a load of 200 g by using a tester (manufactured by Tester Sangyo Co., Ltd., Gakushin-type rubbing fastness tester AB-301S). The test was performed at the level of wet state according to Japanese Industrial Standard (JIS) JIS L0849 for confirming the degree of peeling of ink, and wet rubbing fastness was evaluated by confirming the recording surface after the rubbing fastness test.

### Evaluation Criteria

A: The wet rubbing fastness test showed a flawed/peeled area at a ratio of less than 5% and at grade 3 or higher.
B: The wet rubbing fastness test showed a flawed/peeled area at a ratio of less than 10% and at grade 2 to 3.
C: The wet rubbing fastness test showed a flawed/peeled area at a ratio of less than 50% and at grade 2 or higher.
D: The wet rubbing fastness test showed a flawed/peeled area at a ratio of 50% or more or at lower than grade 2.

### 2.4. Quality of Boundary Portion

In addition to the conditions described above in 2.1., a single-color line pattern having a width of 0.2 mm was further formed as a recording region A by using each of the colored ink compositions 1 to 3. In addition, a clear print portion having a width of 0.1 mm or 0.5 mm was provided as a non-recording region B by using the clear ink composition in the periphery of the solid pattern and the line pattern. With exception of this, the same transfer step as described above in 2.1. was performed, producing a recorded matter. Example 15 is an example without being provided with the non-recording region B.

It was confirmed by visual observation whether or not disturbance occurs at the boundary portion between the solid pattern and the region corresponding to the non-recording region B in the periphery thereof, that is, at the boundary between a color portion and a clear portion, of the recorded matter produced as described above, and the quality of the boundary portion was evaluated according to the following criteria.

Evaluation criteria
A: The length ratio of disturbance at the boundary portion was less than 5%.
B: The length ratio of disturbance at the boundary portion was 15% or more and less than 10%.
C: The length ratio of disturbance at the boundary portion was 10% or more.
   2.5. Quality of thin-line portion

It was confirmed by visual observation whether or not a portion where transfer does not proceeds is present in the line pattern of the recorded matter produced as described above, and transferability was evaluated according to the following criteria.

### Evaluation Criteria

A: The thin line having a width of 0.2 mm could be transferred at a length ratio of 100%.
B: The thin line having a width of 0.2 mm could be transferred at a length ratio of 90% or more and less than 100%.
C: The thin line having a width of 0.2 mm could be transferred at a length ratio of 50% or more and less than 90%.
D: The thin line having a width of 0.2 mm could be transferred at a length ratio of less than 50%.
   2.6. Blurring between color portion and clear portion

It was confirmed by visual observation whether or not blurring occurs at the boundary portion between the solid pattern and the region corresponding to the non-recording region B in the periphery thereof, that is, at the boundary between a color portion and a clear portion, of the recorded matter produced as described above, and blurring between the color portion and the clear portion was evaluated according to the following criteria.

### Evaluation Criteria

A: Blurring was not observed in the boundary portion.
B: Blurring was slightly observed in the boundary portion.
C: Blurring was significantly observed in the boundary portion.

TABLE 2

| | | Example | | | | | | | |
|---|---|---|---|---|---|---|---|---|---|
| | | 1 | 2 | 3 | 4 | 5 | 6 | 7 | 8 |
| Colored ink | Colored ink composition No. | 1, 2, 3 | 1, 2, 3 | 1, 2, 3 | 1, 2, 3 | 1, 2, 3 | 1, 2, 3 | 1, 2, 3 | 1, 2, 3 |
| adhering step | Colored ink duty [%] | 5 | 5 | 5 | 10 | 10 | 10 | 20 | 30 |
| Clear ink | Clear ink composition No. | 1 | 2 | 1 | 1 | 1 | 2 | 1 | 1 |
| adhering step | Clear ink duty [%] | 25 | 25 | 35 | 30 | 90 | 90 | 10 | 10 |
| Total duty [%] | | 30 | 30 | 40 | 40 | 100 | 100 | 30 | 40 |
| Difference in surface tension \|S₁-S₂\| | | 0.1~0.2 | 5.5~5.8 | 0.1~0.2 | 0.1~0.2 | 0.1~0.2 | 5.5~5.8 | 0.1~0.2 | 0.1~0.2 |
| Evaluation | Transferability | B | B | A | A | A | A | B | A |
| | Blurring between colored inks 1, 2, and 3 | A | B | A | A | A | B | A | A |
| | Rubbing fastness | A | A | A | A | A | A | B | B |
| | | | | | | | | Comparative | |
| | | Example | | | | | | Example | |
| | | 9 | 10 | 11 | 12 | 13 | 14 | 1 | 2 |
| Colored ink | Colored ink composition No. | 1, 2, 3 | 1, 2, 3 | 1, 2, 3 | 1, 2, 3 | 1, 2, 3 | 1, 2, 3 | 1, 2, 3 | 1, 2, 3 |
| adhering step | Colored ink duty [%] | 30 | 30 | 50 | 50 | 90 | 90 | 10 | 20 |
| Clear ink | Clear ink composition No. | 1 | 2 | 1 | 2 | 1 | 1 | — | — |
| adhering step | Clear ink duty [%] | 70 | 70 | 50 | 50 | 10 | 30 | 0 | 0 |
| Total duty [%] | | 100 | 100 | 100 | 100 | 100 | 120 | 10 | 20 |
| Difference in surface tension \|S₁-S₂\| | | 0.1~0.2 | 5.5~5.8 | 0.1~0.2 | 5.5~5.8 | 0.1~0.2 | 0.1~0.2 | — | — |
| Evaluation | Transferability | A | A | A | A | A | A | E | D |
| | Blurring between colored inks 1, 2, and 3 | A | B | A | B | A | B | A | A |
| | Wet rubbing fastness | A | A | A | A | A | A | D | D |

TABLE 3

| | | Example | | | | | |
|---|---|---|---|---|---|---|---|
| | | 15 | 16 | 17 | 18 | 19 | 20 |
| Colored ink adhering step | Colored ink composition No. | 1, 2, 3 | 1, 2, 3 | 1, 2, 3 | 1, 2, 3 | 1, 2, 3 | 1, 2, 3 |
| | Colored ink duty [%] | 5 | 5 | 5 | 5 | 20 | 5 |
| Clear ink adhering step | Clear ink composition No. | 1 | 1 | 1 | 1 | 1 | 1 |
| | Color portion: clear ink duty [%] | 25 | 25 | 25 | 25 | 80 | 25 |
| | Clear portion: clear ink duty [%] | 0 | 20 | 30 | 30 | 30 | 50 |
| | Clear portion printing range | — | Periphery | Periphery | Periphery | Periphery | Periphery |
| | | | 0.5 mm | 0.5 mm | 0.1 mm | 0.1 mm | 0.1 mm |
| Total duty [%] | | 30 | 30 | 30 | 30 | 100 | 30 |
| Difference in surface tension \|S₁-S₂\| | | 0.1~0.2 | 0.1~0.2 | 0.1~0.2 | 0.1~0.2 | 0.1~0.2 | 0.1~0.2 |
| Evaluation | Transferability | B | B | B | B | A | B |
| | Quality of boundary portion | C | B | A | B | B | A |
| | Quality of thin line portion | D | C | A | B | B | A |
| | Blurring between color | — | A | A | A | A | A |
| | portion and clear portion | | | | | | |

| | | Example | | | | Comparative Example |
|---|---|---|---|---|---|---|
| | | 21 | 22 | 23 | 24 | 3 |
| Colored ink adhering step | Colored ink composition No. | 1, 2, 3 | 1, 2, 3 | 1, 2, 3 | 1, 2, 3 | 1, 2, 3 |
| | Colored ink duty [%] | 5 | 20 | 20 | 20 | 20 |
| Clear ink adhering step | Clear ink composition No. | 1 | 1 | 2 | 1 | — |
| | Color portion: clear ink duty [%] | 25 | 80 | 80 | 80 | 0 |
| | Clear portion: clear ink duty [%] | 100 | 100 | 100 | 120 | 0 |
| | Clear portion printing range | Periphery | Periphery | Periphery | Periphery | — |
| | | 0.1 mm | 0.1 mm | 0.1 mm | 0.1 mm | |
| Total duty [%] | | 30 | 100 | 100 | 100 | 20 |
| Difference in surface tension \|S₁-S₂\| | | 0.1~0.2 | 0.1~0.2 | 5.5~5.8 | 0.1~0.2 | — |
| Evaluation | Transferability | B | A | A | A | D |
| | Quality of boundary portion | A | A | A | A | C |
| | Quality of thin line portion | A | A | A | A | D |
| | Blurring between color | A | A | B | B | — |
| | portion and clear portion | | | | | |

### 3. Evaluation Result

Tables 2 to 3 show the evaluation results of the inks used in the examples. Table 2 indicates that in the recording method using the intermediate transfer medium having the peeling layer, the clear ink composition is adhered to the recording medium and used, thereby improving transferability, suppressing blurring, and also improving wet rubbing fastness. Also, Table 3 indicates that when the clear ink composition is further adhered to the non-recording region, the quality of the boundary portion and the thin-line portion is more improved, and blurring between the color portion and the clear portion is suppressed. The examples described in Table 3 also show good transferability.

In addition, a case using water in place of the clear ink composition was examined, but the case using water showed poor transferability and significant blurring.

What is claimed is:

1. A recording method comprising:
a colored ink adhering step of adhering a colored ink composition to an intermediate transfer medium by an ink jet method to form a recording region A; and
a clear ink adhering step of adhering a clear ink composition to at least a portion of the recording region A,
wherein the colored ink composition contains a sublimation dye, a water-soluble organic solvent, and water; and
the intermediate transfer medium has a peeling layer containing a resin.

2. The recording method according to claim 1, wherein in the clear ink adhering step, the clear ink composition is adhered to a recording region A1, to which the colored ink composition is adhered in an amount of less than 21 mg/inch², in the recording region A.

3. The recording method according to claim 1, wherein in the clear ink adhering step, the clear ink composition is further adhered to a non-recording region B adjacent to the recording region A.

4. The recording method according to claim 1, wherein the total amount of the colored ink composition and the clear ink composition adhered to the recording region A is 6.3 to 25.2 mg/inch².

5. The recording method according to claim 1, wherein the resin contained in the peeling layer contains one or more selected from the group consisting of polyester, polystyrene, polyacryl, polystyrene-acrylic resin, poly(ethylene-vinyl acetate), and a polymer based on diallyl methyl ammonium chloride.

6. The recording method according to claim 1, wherein the glass transition point of the resin contained in the peeling layer is 100° C. or more and 200° C. or less.

7. The recording method according to claim 1, wherein the clear ink composition contains a water-soluble organic solvent and water.

8. The recording method according to claim 7, wherein the absolute value of difference between the surface tension S₁ of the colored ink composition and the surface tension S₂ of the clear ink composition is within 5.0.

9. The recording method according to claim 1, wherein the colored ink composition and the clear ink composition contain the same one or more water-soluble organic solvents.

10. The recording method according to claim 1, wherein in the clear ink adhering step, the clear ink composition is adhered to at least a portion of the recording region A by an ink jet method.

11. The recording method according to claim 1, further comprising a transfer step of transferring an image formed in the recording region A to the surface of the recording medium by heating in a state where in the intermediate transfer medium, the surface having the recording region A formed thereon faces the surface of the recording medium.

12. The recording method according to claim 11, wherein the heating temperature in the transfer step is 160° C. to 190° C.

13. The recording method according to claim 11, wherein the transfer step is performed in a state where the total amount of the colored ink composition and the clear ink composition adhered to the recording region A is 5.0 mg/inch² or more.

14. The recording method according to claim 11, wherein the recording medium is a fabric containing cotton.

15. An ink jet recording apparatus used for the recording method according to claim 1, comprising:
a nozzle that ejects a colored ink composition; and
a nozzle that ejects a clear ink composition,
wherein the colored ink composition contains a sublimation dye, a water-soluble organic solvent, and water; and
the clear ink composition contains a water-soluble organic solvent and water.
